(19) United States
(12) Patent Application Publication
(10) Pub. No.: US 2006/0272183 A1
(43) Pub. Date: Dec. 7, 2006

(54) Ground-clearing apparatus

(76) Inventor: Craig Kergen, Crossfield (CA)

Correspondence Address: GOWLING LAFLEUR HENDERSON LLP, SUITE 1400, 700 2ND ST. SW, CALGARY, AB, T2P 4V5, CA

(21) Appl. No.: 11/144,675

(22) Filed: Jun. 6, 2005

(51) Int. Cl. A01B 13/00

(52) U.S. Cl. 37/301

(57) ABSTRACT

A ground-clearing apparatus for mounting on a vehicle, comprising a housing containing a rotatably mounted cylindrical drum, the cylindrical drum being provided with a plurality of teeth, and a door in the housing pivotably connected to the housing and openable in a direction away from the vehicle. Preferably, the vehicle is a track vehicle; the housing is bi-directional, containing vertically-disposed fracture boards, and is pivotable to selectively enable engagement of the plurality of teeth with the ground surface; and a V-shaped push bar is pivotably mounted on the housing. The apparatus preferably further comprises height-adjustable skid shoes on the housing for adjusting the vertical distance between the drum and the skid shoes.

### FIELD OF THE INVENTION

This invention relates to ground-clearing and ground-breaking equipment, and more particularly to equipment useful in clearing wooded terrain.

### BACKGROUND OF THE INVENTION

Clearing wooded terrain, such as lease sites or proposed farmland, typically requires three or four pieces of specialized equipment. Any smaller trees on the terrain are usually pushed over by the equipment, and the trees are then windrowed or left in piles. This material is often left where it has been piled, for years in some cases, and it can become a significant fire hazard during dry periods. During wet periods, when there is substantial rainfall, the removal of these smaller trees leaves the ground with no residual organic stabilizing material, resulting in extensive ground erosion damage.

It is known to employ ground-breaking equipment when preparing or altering roadways in areas such as those described above, including equipment such as rotary mills having a massive toothed drum. For example, U.S. Pat. No. 5,259,692 to Beller et al. teaches a ground-breaking apparatus for mounting on the type of wheeled vehicle commonly found in road construction, such as a loader. The Beller apparatus comprises a toothed cylinder partially contained within a shield or housing, the shield including fracture boards and wear plates arranged on its inner surface for breaking up detritus drawn in by rotation of the cylinder.

The Beller apparatus, however, is mounted on wheeled equipment (a specific limitation addressed to cost savings, as the apparatus could be mounted on vehicles already present at the job site), and is accordingly limited to terrain of moderate grade and minimal snow cover. The Beller apparatus is not designed to work in off-road, forest-like conditions, but rather for working or altering a relatively clear ground surface or existing road surface. While the Beller apparatus could theoretically be used to clear land, it could not mulch, mill and slash in only one or two passes, and, undesirably, two engines are specifically required (an auxiliary engine being necessary to drive the toothed cylinder). In addition, the fracture board arrangement does not lend itself to changing the direction of cylinder rotation where such might be desirable.

What is needed is a ground-clearing apparatus that can be used with vehicles capable of use in off-road, wooded conditions.

### SUMMARY OF THE INVENTION

The present invention provides a ground-clearing apparatus that can be used with existing track equipment, having a structure specifically addressed to wooded terrain.

According to a first aspect of the present invention there is provided a ground-clearing apparatus for mounting on a vehicle, the apparatus comprising: mounting means for mounting the apparatus on the vehicle; a frame connected to the mounting means; a housing connected to the frame; a cylindrical drum rotatably mounted within the housing, the cylindrical drum being provided with a plurality of teeth, the housing partially surrounding the drum; and a door in the housing, pivotably connected to the housing and openable in a direction away from the mounting means.

According to a second aspect of the present invention there is provided a vehicle for moving across a ground surface, the vehicle being provided with a ground-clearing apparatus, the ground-clearing apparatus comprising: a frame mounted on the vehicle; a housing connected to the frame; a cylindrical drum rotatably mounted within the housing, the cylindrical drum being provided with a plurality of teeth, the housing partially surrounding the drum; and a door in the housing, pivotably connected to the housing and openable in a direction away from the vehicle.

In exemplary embodiments of the present invention, the vehicle is a track vehicle, with tracks for moving across a ground surface. The housing is preferably pivotable with respect to the frame to selectively enable engagement of the plurality of teeth with the ground surface, and most preferably this pivoting is accomplished by hydraulic means. A push bar is preferably mounted on the housing, and most preferably pivotably mounted to pivot from a forward orientation in a direction away from the vehicle to an upward orientation. While the push bar can employ a straight leading edge, it is preferable to provide the push bar with a V-shaped leading edge.

The apparatus preferably further comprises skid shoes on the housing for slidable engagement with the ground surface, and most preferably comprises adjustment means for adjusting the vertical distance between the drum and the skid shoes; in this way, ground penetration can be controlled, and the adjustment means preferably also comprise means for selectively controlling the vertical distance. The adjustment means may comprise end plates at opposed ends of the housing perpendicular to the direction of travel, the skid shoes mounted on skid shoe plates, and the skid shoe plates slidably connected to the end plates, such that the skid shoe plates can be vertically adjusted relative to the end plates.

The housing is preferably provided with at least one fracture board on an inner surface, to assist in pulverizing detritus drawn into the housing by the toothed drum. A housing according to the present invention is preferably bi-directional, capable of operation in either direction of rotation, and accordingly the fracture boards are preferably vertically-disposed. Horizontally-disposed fracture boards, such as those taught by Beller et al., are often designed for use in a single direction of rotation.

An apparatus or vehicle according to the present invention, then, can be employed with steep terrain, areas of substantial snow cover or frozen ground, and forest-like conditions. As described in detail below, an apparatus or vehicle according to the present invention can be used to mulch, mill and/or slash in one or two passes, leaving mulch fibre in the ground to aid in stabilization during wet periods. The pivotable door can be opened to allow small trees to contact the toothed drum, and the optional push bar bends small trees to enable the apparatus to chew the trees closer to the ground. The preferred V-shaped push bar provides the advantage of directing the trees toward the middle of the apparatus to assist in processing, while the adjustable skid shoes and housing tilting provide advantageous control over ground penetration. In addition, where stripping frozen ground for oilfield and pipeline construction settings, an apparatus according to the present invention helps to reduce admixing of soil types (e.g. top soil and underlying clay), taking the place of a ripper CAT™ and addressing deficiencies of same. Other advantages will become obvious in the following.

A detailed description of an exemplary embodiment of the present invention is given in the following. It is to be understood, however, that the invention is not to be construed as limited to this embodiment.

### BRIEF DESCRIPTION OF THE DRAWINGS

In the accompanying drawings, which illustrate an exemplary embodiment of the present invention:

FIG. 1 is a rear perspective view of a ground-clearing apparatus according to the present invention, illustrating a V-shaped push bar;

FIG. 2 is a partially exploded view of the ground-clearing apparatus of FIG. 1, showing some of the elements involved in tilting the ground-clearing apparatus;

FIG. 3 is a schematic side view of the ground-clearing apparatus, tilted to a maximum downward position for maximum ground penetration;

FIG. 4 is a schematic side view of the ground-clearing apparatus, tilted to a medium position, the housing generally level and engaging the ground to a minimal extent;

FIG. 5 is a schematic side view of the ground-clearing apparatus, tilted to a maximum upward position, spaced from the ground;

FIG. 6a is a top perspective view of the housing, showing the opening the door would cover when desired;

FIG. 6b is a bottom perspective view of the housing;

FIG. 7 is a front perspective view of the ground-clearing apparatus, illustrating a straight push bar in raised position and showing the housing door in both open and closed positions;

FIG. 8 is a schematic side view of the ground-clearing apparatus, illustrating the push bar forwardly extended and the housing door in the open position, the housing being unidirectional;

FIG. 8a is a schematic side view of a bi-directional housing;

FIG. 9 is a schematic side view of the ground-clearing apparatus, illustrating the push bar raised and the housing door in the open position;

FIG. 10 is a detailed schematic side view showing the hydraulic cylinder and linkages controlling the housing door, the door in the open position; and

FIG. 11 is a detailed schematic side view as in FIG. 10, the door in the closed position.

### DETAILED DESCRIPTION OF A PREFERRED EMBODIMENT

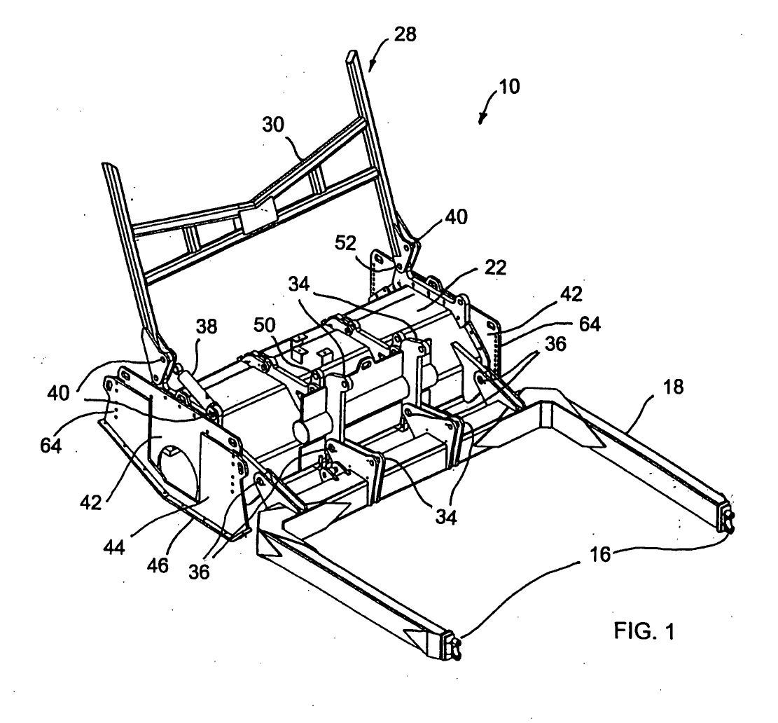

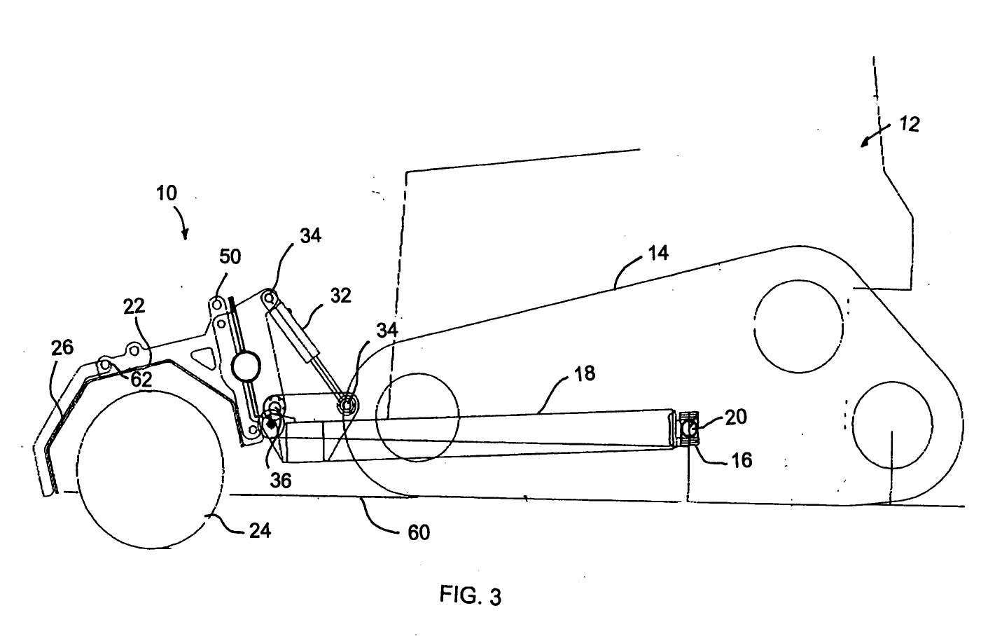

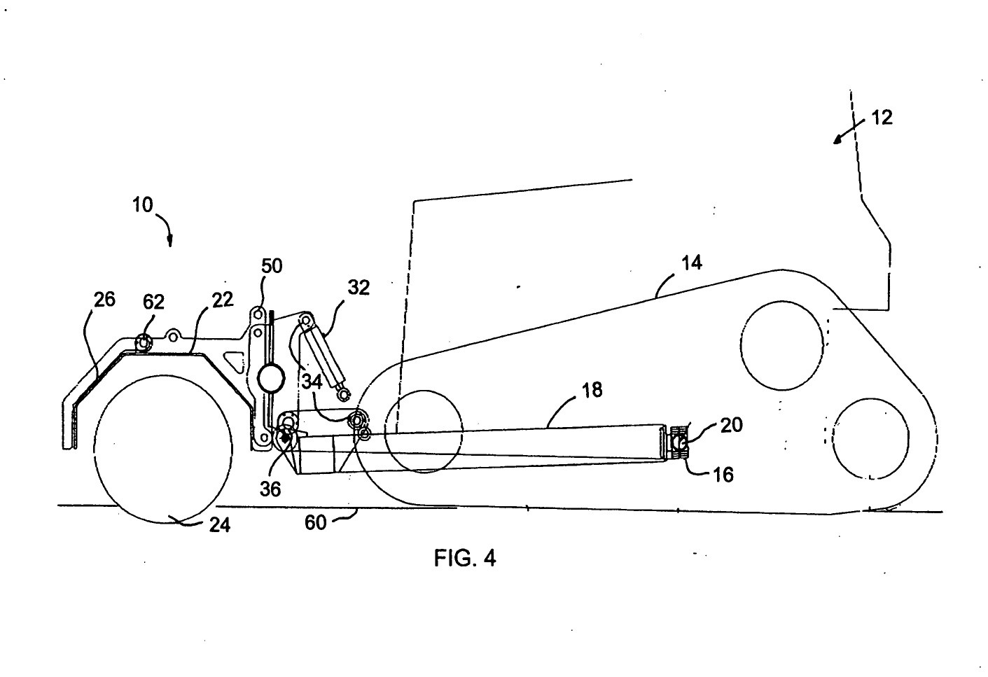

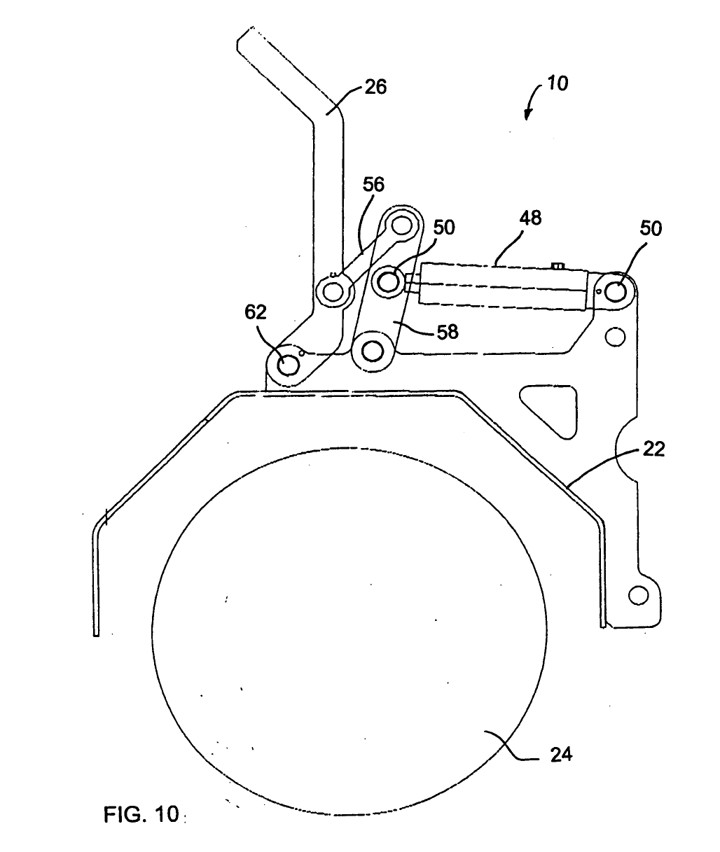

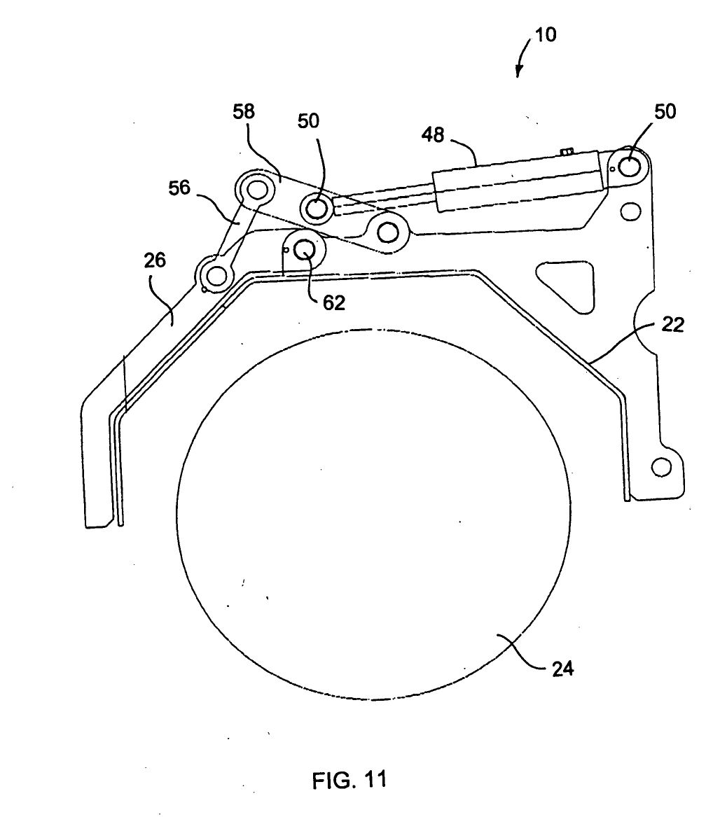

Referring now in detail to the accompanying drawings, there is illustrated an exemplary embodiment of a ground-clearing apparatus according to the present invention generally referred to by the numeral 10. As can best be seen in FIGS. 1, 2, 10 and 11, the ground-clearing apparatus 10 comprises mounting brackets 16 for mounting a frame 18 on a vehicle 12 having tracks 14 (shown in outline in FIGS. 3, 4 and 5), a housing 22 connected to the frame 18, a cylindrical drum 24 rotatably mounted within and partially covered by the housing 22, and a door 26 provided in the housing 22. The housing 22 and drum 24 portion of the ground-clearing apparatus 10 is also referred to herein as a “cutter head”.

As shown in FIGS. 3, 4 and 5, the mounting brackets 16 of the frame 18 connect to trunnions 20 on both of the vehicle 12 sides; existing hydraulics, not shown, of the vehicle 12 may therefore be used to pivotably rotate the frame 18 as desired. As stated above, the ground-clearing apparatus 10 can be installed on existing track equipment, such as a D6R track-type tractor manufactured by Caterpillar Inc. The mounting brackets 16 would be connected where the ripper or winch is normally positioned on the D6R machine. The C-shaped frame 18 can be sized to fit whatever vehicle 12 is desirable in a given situation, constructed with sufficient strength to accommodate the cutter head. The frame 18 is also provided with an attachment (not shown) to secure existing hydraulic cylinders on the front of the vehicle 12 to be able to raise and lower the frame 18 and the cutter head.

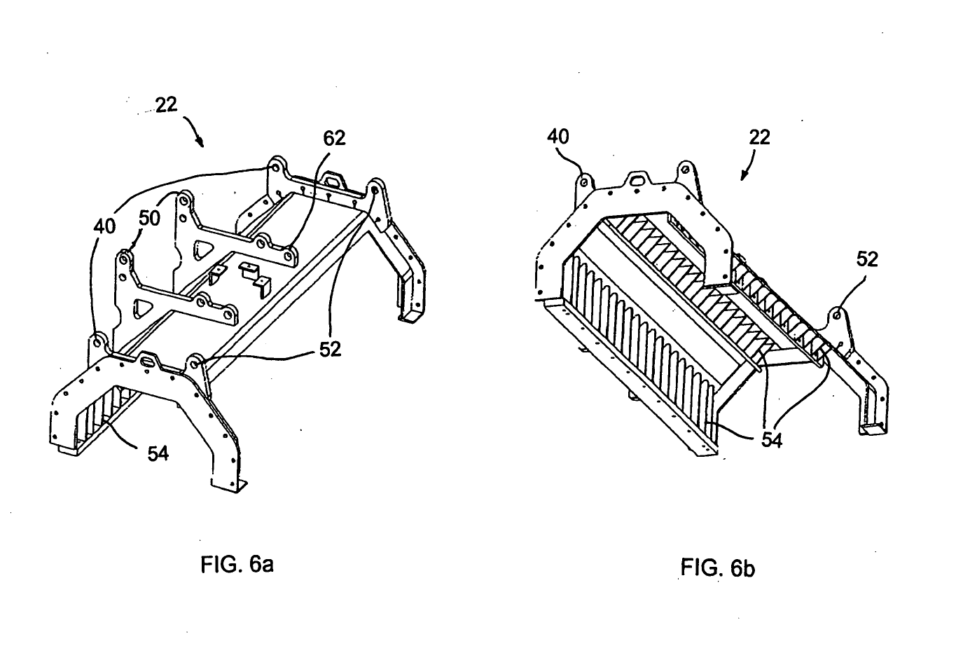

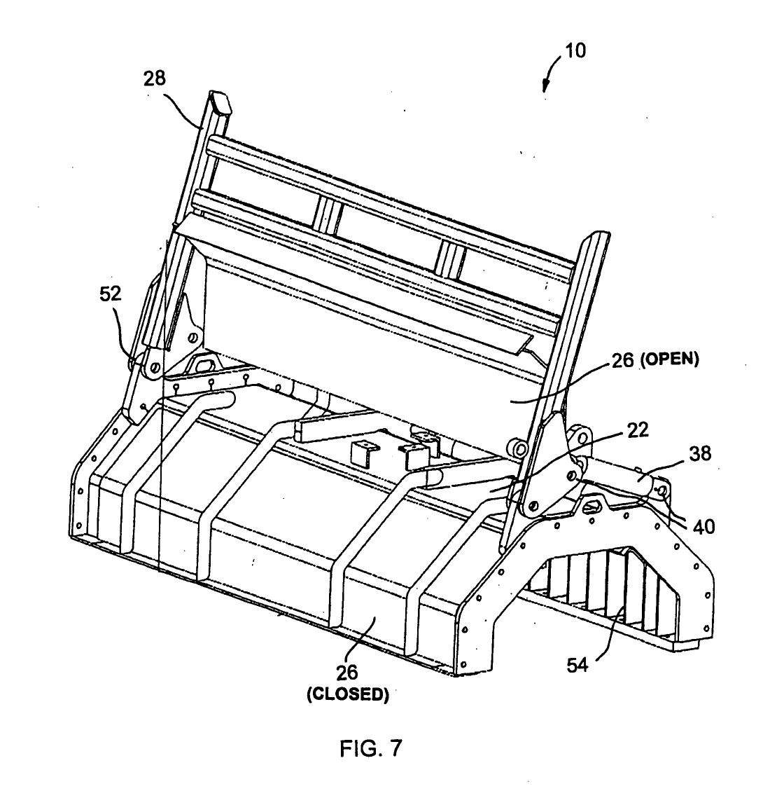

As stated above, the housing 22 is provided with a door 26. Referring to FIGS. 6a and 6b, it can be seen that the housing 22 is open along one side, which is the opening that will be covered by the door 26 when desired. The door 26 is pivotable and hydraulically-controlled, opening to allow standing trees and other large objects to enter into proximity with the drum 24. As can best be seen in

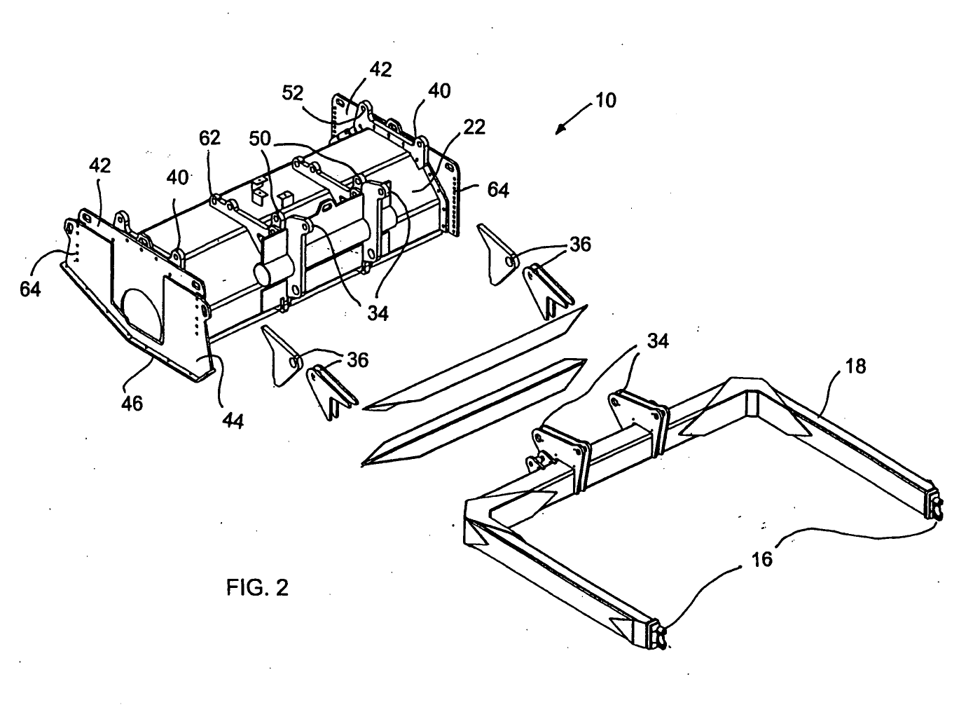

FIGS. 2, 10 and 11, the door 26 is in pivotal engagement with the housing 22 at pivot points 62, and the pivoting is controlled by hydraulic cylinders 48 which are connected to the housing 22 and door 26 at connection points 50. The forward connection points 50 are located on linkages 58, and linkages 56, 58 transmit the extension of the hydraulic cylinders 48 into a force that pivots the door 26 about the pivot points 62, opening and closing the door 26 as desired. The ability to open and close the door 26 provides diverse operational functionality; for example, the drum 24 could be performing an “up cut” while driving the vehicle 12 forward on a first pass (the leading face of the drum 24 moving upwardly against adjacent objects), the door 26 remaining open to allow trees and brush to contact the drum 24 and its teeth; the door 26 can then be bolted or pinned shut, allowing the affected material to be milled and shredded against the fracture boards 54 mounted inside the housing 22 on a subsequent pass, the apparatus 10 grinding and mulching the wood, stump and brush residue into the ground. A pivotable door 26 also allows an operator to open the door 26 to enable service of the cutter head. FIG. 7 shows the door 26 in two orientations, open and closed.

The housing 22 is designed to be bi-directional, meaning that the drum 24, complete with teeth and gear boxes (not shown), can be turned end-for-end allowing the drum 24 to rotate in the opposite direction. Such a bi-directional housing 22 allows the operator the choice of driving ahead while grinding the subject material, rather than having to reverse back over the material, and the fracture boards 54 are mounted in the housing 22 to impact and shred the material when running the drum 24 in either direction. FIGS. 6a and 6b show the preferred fracture board 54 arrangement, being vertically disposed to enable reversing of the direction of rotation.

The drum 24 is provided with teeth (not shown), in a manner similar to Beller et al.; however, the teeth arrangement and configuration could be adjusted to suit the particular situation (Beller et al. being primarily directed to hard materials and rock), as would be clear to someone skilled in the art. The drum 24 is also mounted within the housing 22 in a manner similar to that taught by Beller et al. Drums 24 according to the present invention can have between 138 and 198 teeth, the lower end being for muddy conditions (to avoid plugging of the cutter head), but it is most preferable for standard wooded terrain to provide the drum 24 with 158 one-inch carbide teeth. The teeth would be machined as necessary for particular situations, including various widths and arrangements on the drum 24.

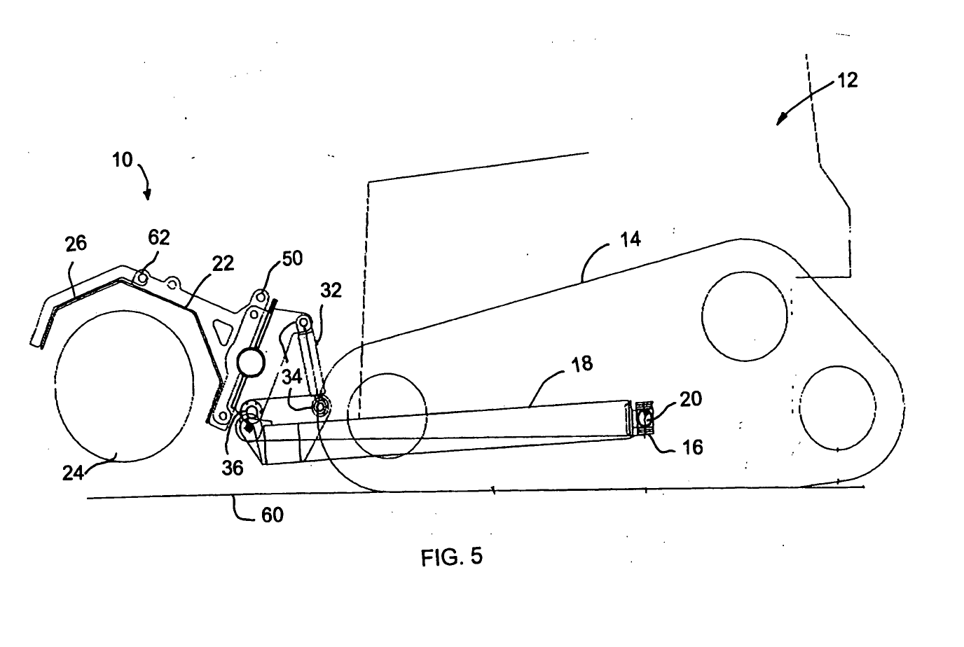

Tilting of the cutter head, comprising the housing 22 and drum 24, is also hydraulically-controlled, as can be seen in FIGS. 2 through 5. Hydraulic cylinders 32 are connected to the frame 18 and housing 22 at connection points 34, the housing 22 then being pivotable relative to the frame 18 at pivot points 36. By pivoting the cutter head, ground penetration can be controlled, and the cutter head can be completely disengaged from the ground 60, as can be seen in FIG. 5.

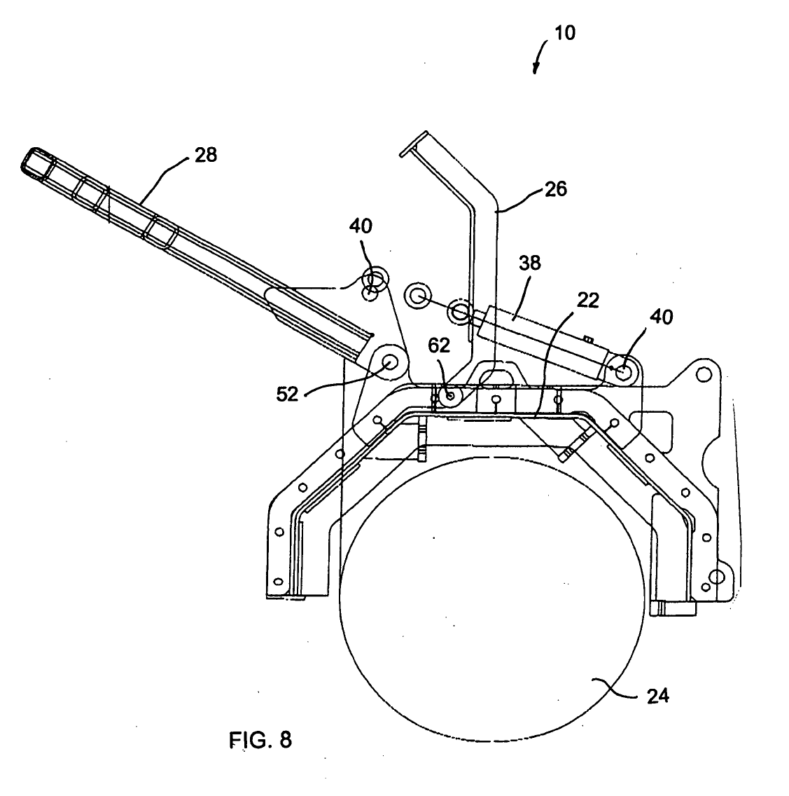

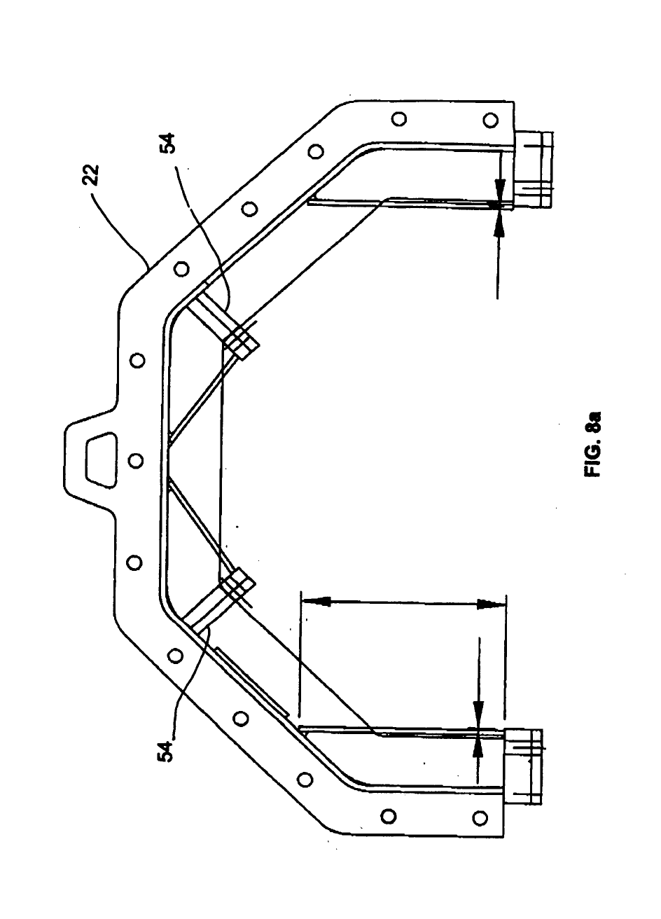

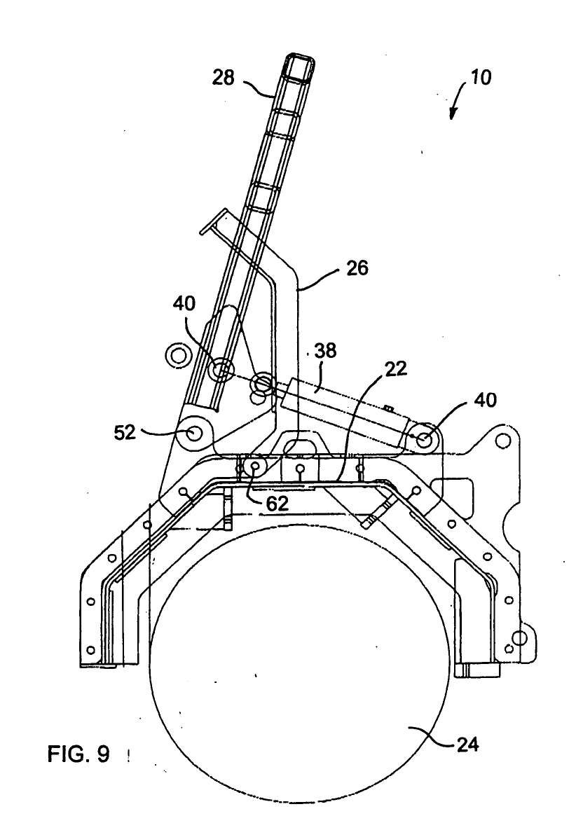

As mentioned above, the housing 22 is preferably provided with a push bar to contact encountered trees and brush. As can be seen in FIGS. 1 and 7, respectively, the leading edge 30 of the push bar 28 can be either V-shaped or straight, and other configurations will now be obvious to one skilled in the art. The push bar 28 is hydraulically-controlled and mounted above the door 26, protruding in front of the apparatus 10 when in the forward orientation. FIGS. 8 and 9 illustrate the push bar 28 and associated hydraulic mechanism. The push bar 28 is pivotable relative to the housing 22 at pivot point 52, and the pivoting is driven by hydraulic cylinders 38 which are connected to the push bar 28 and housing 22 at connection points 40. As a vehicle 12 provided with an apparatus 10 according to the present invention is driven ahead, the push bar 28 leans any trees or tall brush away from the apparatus 10, allowing the drum 24 to cut and chew the trees just above ground level, felling the trees while driving ahead. In the embodiment of FIG. 1, where the push bar 28 is provided with a V-shaped leading edge 30, trees and tall brush can be directed toward the centre of the cutter head, assisting in the processing of the material, and when trees fall ahead of the apparatus 10 they then lay in a straighter line.

In FIG. 8, the housing 22 is unidirectional, having fracture boards 54 disposed accordingly. FIG. 8a illustrates the fracture board 54 arrangement for a bi-directional housing 22.

In preferred embodiments, the engine power pack (not shown) comprises a 525 horsepower engine, with two hydraulic pumps mounted on a gear box. Oil is preferably pumped at high pressure on demand, the oil travelling to the cutter head through flexible hoses (not shown), 6,000 psi rated, connecting to 1½ inch steel hard lines (not shown) mounted on the cab of the vehicle 12, the hard lines assisting in cooling the oil in high-temperature applications. Oil travels to the drive motors (which can be single or two-speed) (not shown) that power the drum 24, mounted each to a gear box (not shown), as is taught by Beller et al. The gear box is bolted in a flange (not shown) in each end of the drum 24. As the oil travels to the cutter head through flexible hoses, this allows the cutter head to move up and down and tilt during operation without disrupting oil supply.

The housing 22 is also provided with adjustable skid shoes 46, which allow for varying the vertical displacement between the skid shoes 46 (and accordingly the ground surface 60) and the lower surface of the drum 24. This, along with the ability to tilt the cutter head as shown in FIGS. 3 to 5, enables the operator to control the depth of penetration into the ground 60. As can best be seen in FIGS. 1 and 2, the housing 22 is provided with end plates 42 which are designed to mate with skid shoe plates 44, the skid shoes 46 being mounted to the bottom edge of the skid shoe plates 44. The end plates 42 and skid shoe plates 44 are provided with corresponding holes 64. To select a desired penetration depth, the operator would raise the end plates 42 relative to the skid shoe plates 44, and then insert a bolt or pin (not shown) through the holes 64 in each of the end plates 42 and skid shoe plates 44, securing the end plates 42 and skid shoe plates 44 in that position. It is also possible to provide hydraulically-actuated depth control as would be obvious to one skilled in the art, although the use of mating plates on the cutter head is mechanically simpler. The skid shoes 46 are hardened, wear-resistant, and replaceable, and can be bolted onto the skid shoe plates 44.

In preferred embodiments of the present invention, the hydraulic system has a nitrogen pre-charge bottle (not shown) mounted in the hydraulic system, containing gallons of hydraulic oil under pressure ready to fill any void if the hydraulic pumps ever surge or cavitate. In addition, an apparatus 10 according to the present invention preferably locates the fuel tank (not shown) between the frame 18 arms for protection from the wooded environment; similarly, a removable plate protector (not shown) is preferably provided to protect the engine from the trees. An accumulator (not shown) may also be employed for shock loading, to keep the pumps from cavitating and burning out.

A control panel (not shown) is preferably located in the cab of the vehicle 12, with all necessary gauges and engine speed controls, as would be obvious to one skilled in the art. The hydraulics for the pivotable door 26 and push bar 28 would then be fully controllable from within the cab.

A vehicle and apparatus according to the present invention have been used in wooded terrain, with positive results. The vehicle was driven straight into standing trees, the trees up to 10 inches thick. The vehicle was able to grind the trees down, including stumps, and mulch the residue into the soil resulting in a generally flat ground surface, in only two passes over the ground surface. The apparatus was provided with 1 inch carbide teeth on a 40 inch diameter two-speed drum. It has been found that the apparatus can process small trees, frozen soil, stumps, roots, and rocky soil, mixing all residue back into the soil. One machine has been used to turn wooded terrain into a generally flat road surface, without the need for specialized equipment for picking stumps or stacking felled trees, and no burning of trees and brush was required.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

Embodiments of the invention in which an exclusive property or privilege is claimed are defined as follows:

1. A ground-clearing apparatus for mounting on a vehicle, the apparatus comprising:
mounting means for mounting the apparatus on the vehicle;
a frame connected to the mounting means;
a housing connected to the frame;
a cylindrical drum rotatably mounted within the housing, the cylindrical drum being provided with a plurality of teeth, the housing partially surrounding the drum; and
a door in the housing, pivotably connected to the housing and openable in a direction away from the mounting means.

2. The apparatus of claim 1 wherein the vehicle is a track vehicle.

3. The apparatus of claim 1 wherein the housing is pivotable with respect to the frame to selectively enable engagement of the plurality of teeth with a ground surface.

4. The apparatus of claim 3 comprising hydraulic means to enable the housing to pivot with respect to the frame.

5. The apparatus of claim 1 further comprising a push bar mounted on the housing.

6. The apparatus of claim 5 wherein the push bar is pivotably mounted on the housing, being pivotable from a forward orientation in a direction away from the mounting means, to an upward orientation.

7. The apparatus of claim 5 wherein the push bar has a V-shaped leading edge.

8. The apparatus of claim I further comprising skid shoes on the housing for slidable engagement with a ground surface.

9. The apparatus of claim 8 further comprising adjustment means for adjusting the vertical distance between the drum and the skid shoes.

10. The apparatus of claim 9 wherein the adjustment means comprise:
end plates at opposed ends of the housing perpendicular to a direction of travel;
the skid shoes mounted on skid shoe plates, the skid shoe plates slidably connected to the end plates;
such that the skid shoe plates can be vertically adjusted relative to the end plates.

11. The apparatus of claim 10 wherein the adjustment means further comprise means for selectively controlling the vertical distance between the drum and the skid shoes.

12. The apparatus of claim 1 wherein an inner surface of the housing is provided with at least one fracture board.

13. The apparatus of claim 1 wherein the housing is bi-directional.

14. The apparatus of claim 13 wherein an inner surface of the housing is provided with at least one vertically-disposed fracture board.

15. A vehicle for moving across a ground surface, the vehicle being provided with a ground-clearing apparatus, the ground-clearing apparatus comprising:
a frame mounted on the vehicle;
a housing connected to the frame;
a cylindrical drum rotatably mounted within the housing, the cylindrical drum being provided with a plurality of teeth, the housing partially surrounding the drum; and
a door in the housing, pivotably connected to the housing and openable in a direction away from the vehicle.

16. The vehicle of claim 15 wherein the vehicle comprises tracks for moving across the ground surface.

17. The vehicle of claim 15 further comprising a push bar pivotably mounted on the housing, pivotable from a forward orientation in a direction away from the vehicle, to an upward orientation, the push bar having a V-shaped leading edge.

18. The vehicle of claim 15 further comprising:
skid shoes on the housing for slidable engagement with the ground surface; and
adjustment means for adjusting the vertical distance between the drum and the skid shoes.

19. The vehicle of claim 15 wherein the housing is bi-directional.

20. The vehicle of claim 15 wherein an inner surface of the housing is provided with at least one vertically-disposed fracture board.
